(19) United States
(12) Patent Application Publication
(10) Pub. No.: US 2019/0321913 A1
(43) Pub. Date: Oct. 24, 2019

(54) SYSTEMS AND METHODS FOR WELDING

(71) Applicant: Faraday&Future Inc., Gardena, CA (US)

(72) Inventors: Phillip John Weicker, Los Angeles, CA (US); Don Suranga Dhanushka Uduwage, Harbor City, CA (US); Hrayr Torosyan, Sunland, CA (US)

(21) Appl. No.: 15/942,323

(22) Filed: Mar. 30, 2018

Related U.S. Application Data
(60) Provisional application No. 62/479,043, filed on Mar. 30, 2017.

(51) Int. Cl. B23K 26/211; B23K 26/00; B23K 26/18

(52) U.S. Cl. CPC B23K 26/211; B23K 26/18; B23K 26/0006

(57) ABSTRACT

A welding method includes providing a first workpiece and a second workpiece, positioning the first workpiece to contact the second workpiece, coating a portion of a selected one of the first and second workpieces with an absorbing layer; and welding the first workpiece and the second workpiece by heating the selected one of the first and second workpieces through the absorbing layer.

### CROSS-REFERENCE TO RELATED APPLICATIONS

This application claims the priority benefit of U.S. Provisional Application No. 62/479,043, filed Mar. 30, 2017, the entirety of which is hereby incorporated by reference.

### TECHNICAL FIELD

The present disclosure relates generally to the field of welding methods, and more particularly, to systems and methods for laser welding of reflective workpieces.

### BACKGROUND

Certain manufacturing processes require welding of multiple components. For example, the fabrication of batteries that have a plurality of cells may require welding of several terminals to bus bars, or similar conductive elements, to connect the plurality of cells. These processes may be efficiently performed with automated welding systems that are well suited for high volume applications. Automated systems based on techniques such as laser beam welding (LBW) or electron beam welding (EBW) may provide the high welding rates, deep weld profiles, and narrow welding resolutions that are required in some manufacturing processes. These automated systems may also be used to weld elements with complex geometries that require specific welding conditions and that may be part of an automated production line.

Although conventional automated welding systems may be suitable for some applications, they are deficient in other applications. For example, automated systems based on LBW may be difficult or impractical to utilize when reflective metals, such as copper, are welded. The reflectivity of some materials may prevent sufficient absorption of the laser energy, which could result in poor welding characteristics, a diminished welding rate, or requirements for higher than average laser power sources. In certain scenarios, welding with LBW may require longer exposures to achieve welding temperatures, or may necessitate expensive lasers with unconventional power and wavelength. Hence, in these scenarios it may be desirable to modify the material properties of the metal being welded to facilitate welding processes with welding methods such as LBW.

The disclosed welding method of the present disclosure is directed to mitigating or solving the above described and/or other problems in the art.

### SUMMARY

One aspect of the present disclosure is directed to a welding method. The method includes providing a first workpiece and a second workpiece, positioning the first workpiece to contact the second workpiece, coating a portion of a selected one of the first and second workpieces with an absorbing layer; and welding the first workpiece and the second workpiece by heating the selected one of the first and second workpieces through the absorbing layer.

Another aspect of the present disclosure is directed to a welding method. The method includes providing a first workpiece, coating at least a portion of the first workpiece with an absorbing layer, positioning the first workpiece and a second workpiece in contact with the absorbing layer exposed, and welding the first workpiece to the second workpiece by heating the first workpiece through the absorbing layer.

Yet another aspect of the present disclosure is directed to a system for welding workpieces. The system includes a heat source configured to heat a first workpiece, a coating device configured to coat an absorbing layer onto the first workpiece, an actuator coupled to the heat source and the coating device to move the heat source along a first axis and a second axis, and a controller, to control the actuator, heat source, and depositing device. The actuator executes operations to coat, by the coating device, an absorbing layer onto the first working piece, and weld, by the heat source, the first workpiece to a second workpiece in contact with the first working piece, by heating through the absorbing layer.

### BRIEF DESCRIPTION OF THE DRAWINGS

FIG. 1 is a diagrammatic illustration of a laser welding system, according to a disclosed embodiment.

FIG. 2 is an exemplary illustration of a workpiece prepared for welding, according to a disclosed embodiment.

FIG. 3 is a cross section diagram illustrating exemplary workpieces with an absorbing layer applied for welding, according to a disclosed embodiment.

FIG. 4 is a flowchart illustrating an exemplary process for welding a workpiece, according to a disclosed embodiment.

FIG. 5 is a flowchart illustrating an exemplary process for welding a first workpiece with a second working piece, according to a disclosed embodiment.

### DETAILED DESCRIPTION

The disclosure is generally directed to welding methods and systems that facilitate or enable welding reflective workpieces with heat sources such as lasers and electron beams. In some embodiments, the welding method includes coating a workpiece with an absorbing layer. In some embodiments, the absorbing layer enhances absorption of heat, is electrically nonconductive, and can be applied by any of a plurality of apparatuses to have a desired thickness and composition. In some embodiments the absorbing layer may be removable after the welding process, be part of the final structure. The welding methods and systems may utilize mixtures of organic and inorganic compounds as the absorbing layer. The composition of the absorbing layer may be selected to withstand the welding process, absorb a range of wavelengths, or form a specific thickness. In some embodiments, the welding methods and systems include equipment to automatically apply an absorbing layer and heat through the absorbing layer with a laser beam. Automated systems consistent with the disclosure improve welding rates, enhance quality, and/or permit line production.

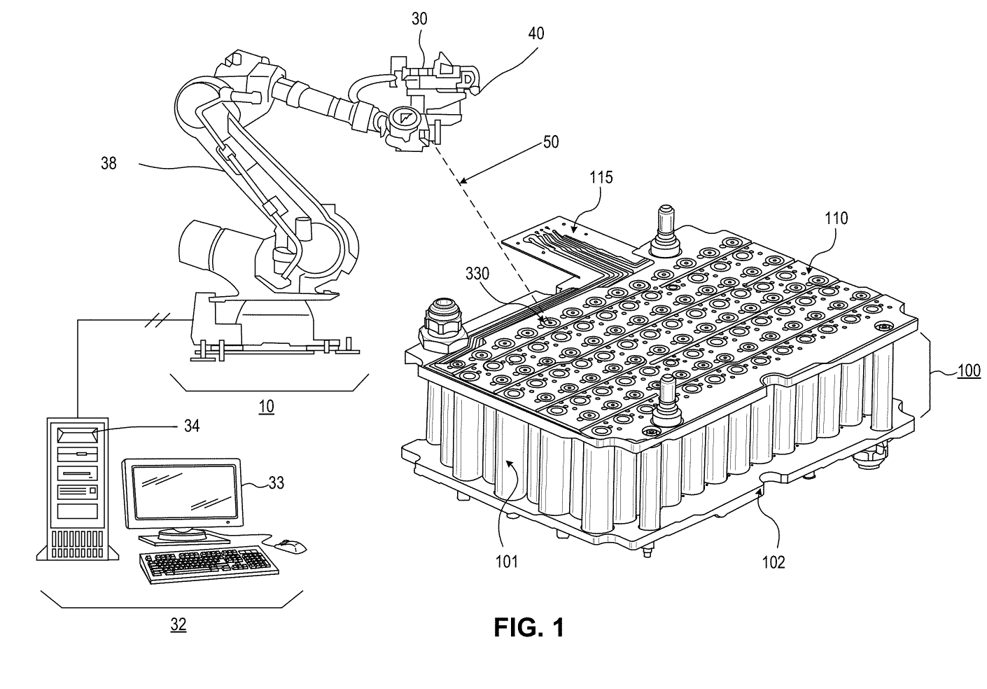

FIG. 1. is a diagrammatic illustration of a laser welding system, according to a disclosed embodiment. The welding system includes a welding tool 10, a controller 32, a first workpiece 110, and a second workpiece 100.

Many different arrangements can be used to mount the different parts of welding tool 10. In the exemplary embodiment of FIG. 1, welding tool 10 includes a laser 30, which may act as a heat source. Laser 30 may be mounted to a robotic arm 38, which is configured to move laser 30 in multiple directions relative to first workpiece 110 and second workpiece 100. In the depicted example, robotic arm 38 is a 6-axis arm regulated by a controller 32 to translate laser 30 in three different directions and to also rotate laser 30 in three different directions. It is contemplated, however, that a different mechanism (e.g., a gantry or a hybrid arm/gantry mechanism) could be used to move laser 30 in the same or a different way, if desired. It is also contemplated that laser 30 may be fixedly mounted in a single position and/or orientation corresponding to a particular weld to be created in first workpiece 110.

Laser 30 is configured to generate and direct one or more polarized laser beams 50 toward first workpiece 110 or second workpiece 100. Laser 30 may include, for example, one or more of an Excimer laser, a Yb:tunstates laser, a CO₂ laser, a Nd:YAG laser, a diode-pumped solid-state (DPSS) laser, or any other type of laser capable of heating workpieces to welding temperature. In the disclosed embodiment, laser 30 is configured to produce a laser beam 50 having a circular or square cross section, with a dimension (e.g., a diameter or width) that is proportional to welded region 330. Laser 30 may also include a solid state laser, a gas laser, or a fiber laser. Laser 30 may be a single wavelength laser (for example a laser emitting at 1000 nm) or a multi-wavelength laser with multiple emission frequencies that may be emitted simultaneously or individually. Further, laser 30 may have a single output power, for example 2 kW, or may have an adjustable output power.

Controller 32 may embody a single processor or multiple processors that include a means for controlling an operation of welding tool 10. Numerous commercially available processors may perform the functions of controller 32. Controller 32 may include or be associated with a memory for storing data such as, for example, an operating condition; design limits; performance characteristics or specifications of first workpiece 110, second workpiece 100, and laser 30; operational instructions; and corresponding quality parameters for the welding process. Various other known circuits may be associated with controller 32, including power supply circuitry, signal-conditioning circuitry, solenoid driver circuitry, communication circuitry, and other appropriate circuitry. Moreover, controller 32 may be capable of communicating with components of welding tool 10 via either wired or wireless transmission.

In some embodiments controller 32 includes a user interface 33 and I/O units 34. User interface 33 displays graphical elements associated with first working piece 110 or second working piece 100. User interface 33 may also display operations that can be performed by welding tool 10. In some embodiments, controller 32 may be executing routines in programs such as LabView® or Matlab® to digitally control drivers of elements in welding tool 10. In addition, user interface 33 may display information from sensors in welding tool 10.

In some embodiments, welding tool 10 includes a dispenser 40 mounted in robotic arm 38. In some embodiments, dispenser 40 may be a spraying nozzle, which is connected to a reservoir with a liquid to be dispensed. Pumps may be connected to the reservoir or the nozzle to pressurize liquid into dispenser 40. In other embodiments, dispenser 40 may be a dripping system with a single or multiple outlets. In such embodiments, dispenser 40 may drive liquids without active elements, for example, by using gravity and capillary forces. Dispenser 40 may also include valves to control liquid flow, such as valves connected to controller 32, which may close or open valves during a coating process.

First workpiece 110 may be a conductive material, generally planar, of any size and dimensions. In some embodiments, first workpiece 110 may be a metal or thermoplastic. Alternatively, first working piece 110 may have a nonconductive substrate where a conductive material has been patterned. In such embodiments, first workpiece 110 may be a flex circuit with a single layer or multiple layers, a printed circuit board, or a bus bar.

Second workpiece 100 may be a second conductive material or a collection of conductive materials. Second workpiece 100 may comprise a plurality of elements that will be interconnected by the first workpiece 110. For example, in some embodiments second workpiece 100 may be a battery arrangement which includes a plurality of battery cells 101. Second workpiece 100 may include a support base 102 that provides mechanical support to, for example, the plurality of battery cells 101.

In some embodiments, the size and shape of the first workpiece and second workpiece may be associated. For example, as it is depicted in FIG. 1, the contour of the first workpiece 110 mimics the contour of the second workpiece 100. In other embodiments, first workpiece may match connection points of the second workpiece. For example, contact elements in first workpiece 110 may mirror terminals of battery cells 101, and create complementary terminals and contacts pairs for welding. Additionally, when workpieces are aligned with each other, first workpiece 110 may be in electrical connection with battery cells 101 and conduct current between battery cells 101 through, e.g., contacts and fuses. In alternative or complementary embodiments, first workpiece 110 may be electrically coupled to an electrical interface 115, which transports signals and/or conducts current to/from second workpiece 100. Electrical interface 115 may include an electrical connector (not shown).

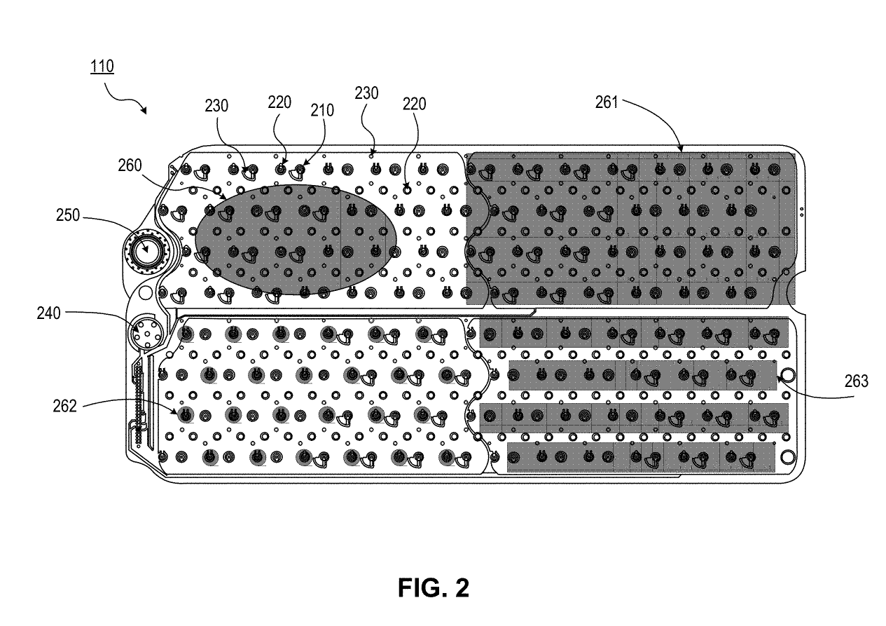

FIG. 2. is an exemplary illustration of a workpiece prepared for welding, according to a disclosed embodiment. Depicted first workpiece 110 includes positive contacts 210, negative contacts 220, and fuses 230. In some embodiments, if the two workpieces are aligned, each positive contacts 210 is in electrical contact with a cathode terminal of one of battery cells 101 and each negative contact 220 is in electrical contact with anode terminal of one of battery cells 101. In such embodiments, positive contacts 210 and negative contacts 220, may be in different layers of the first workpiece 110 and may be separated by dielectric layers to prevent short circuits. In some embodiments, all contacts in first workpiece 110 may be exposed so they can establish electrical contact with the second workpiece.

First workpiece 110 may also include a communications and low power connector 240 and/or a main power connector 250. Communications and low power connector 240 may provide low power, for example, to electronics for data acquisition and/or control, and sensors that may be included in first workpiece 110. In some embodiments, communications and low power connector 240 may be at least partially electrically coupled to first workpiece 110 and controller 32. For example, temperature sensors in first workpiece 110 may communicate through communications and low power connector 240 to monitor the temperature in first workpiece 110 during welding. Main power connector 250 may be electrically coupled to positive contacts 210 and negative contacts 220 and be a node of cumulative potential once first workpiece 110 and second workpiece 100 are welded.

Second workpiece 100 may be coated with an absorbing layer 260. Absorbing layer 260 may be a mixture of organic and inorganic compounds. In some embodiments, the absorbing layer may include one or more of the elements in table 1.

TABLE 1

| | |
|---|---|
| Name | CAS number |

Organic

| | |
|---|---|
| Acetone | 67-64-1 |
| Isopropyl alcohol | 67-63-0 |
| N-butane | 106-97-8 |
| Propane | 74-98-6 |
| N-Heptane | 142-82-5 |
| Naphtha | 64742-88-7 |
| Polytetrafluoroethylene | 9002-84-0 |
| Graphite | 7782-42-5 |

Inorganic

| | |
|---|---|
| Molybdenum disulfide | 1317-33-5 |
| Cerium fluoride | 7440-45-1 |
| Boron nitride | 10043-11-5 |
| Talc | 14807-96-6 |
| Calcium Fluoride | 7789-75-5 |
| Tungsten disulfide | 12138-09-9 |

In some embodiments, absorbing layer 260 may include a plurality of organic elements and a single inorganic element. For example, absorbing layer 260 may include acetone, isopropyl alcohol, butane, and molybdenum disulfide. In this example, multiple ratios and concentrations are contemplated. Acetone may compose 40% of the absorbing layer with isopropyl alcohol at 30%, N-butane at 29%, and molybdenum disulfide at 1%. In other embodiments, absorbing layer 260 may include a single organic element and a plurality of inorganic elements. The composition of absorbing layer 260 may be selected to obtain certain characteristics. For example, different drying times may be obtained by altering the quantity and type of organic components. Also, the absorbing wavelengths and thickness of the layers may be modified by altering the number and type of inorganic components. Additionally, the concentration of elements in Table 1 may be manipulated to modify characteristics such as reflectivity, viscosity, and/or stiction.

In some embodiments, the composition of absorbing layer 260 may be selected to have an electrically nonconductive layer. For example, absorbing layer 260 may include dielectric materials such as polytetrafluoroethylene to generate electrically nonconductive layers. In alternative or additional embodiments, the composition of absorbing layer 260 may be selected to improve absorbing of specific wavelengths. For example, inorganic compounds in absorbing layer 260 may be selected so they absorb infrared and micro wavelengths.

As shown in FIG. 2, absorbing layer 260 may be applied to first workpiece 110 in multiple ways. In some embodiments, absorbing layer 260 may cover full sections of first workpiece 110 in a uniform layer, independent of features in first workpiece 110 (see for example full cover layer 261). In other embodiments, absorbing layer 260 may be applied with specific patterns designed to minimize waste or improve speed. For example, stripes of absorbing layer 260 may be applied on first workpiece 110 (see partial cover layer 262). In yet other embodiments, absorbing layer 260 may be applied only in portions of first workpiece 110 that will be welded (see specific cover layer 263). These embodiments may result from automated dispensing of the absorbing layer by dispenser 40.

The different patterns of absorbing layer 260 with full cover layer 261, partial cover layer 262, or specific cover layer 263 in first workpiece 110 may depend on the apparatus used to apply absorbing layer 260. For example, manual processes may normally apply absorbing layer 260 as full cover layer 261. Additionally, methods of vapor deposition or methods of sticking absorbing layer 260 may also normally apply absorbing layer 260 as full cover layer 261. Alternatively, methods in which absorbing layer 260 is applied with dispenser 40 but the welding process only starts after the layer is cured, may utilize the partial cover layer 262. In addition, methods in which connectors can be immediately welded after dispenser 40 applies absorbing layer 260 (i.e., there is a short curing time) may utilize specific cover layer 263. In this scenarios controller 32 may move robotic arm 38, apply absorbing layer 260 on contacts with dispenser 40, and (without changing position) power laser 30 to weld first workpiece 110 with second workpiece 100.

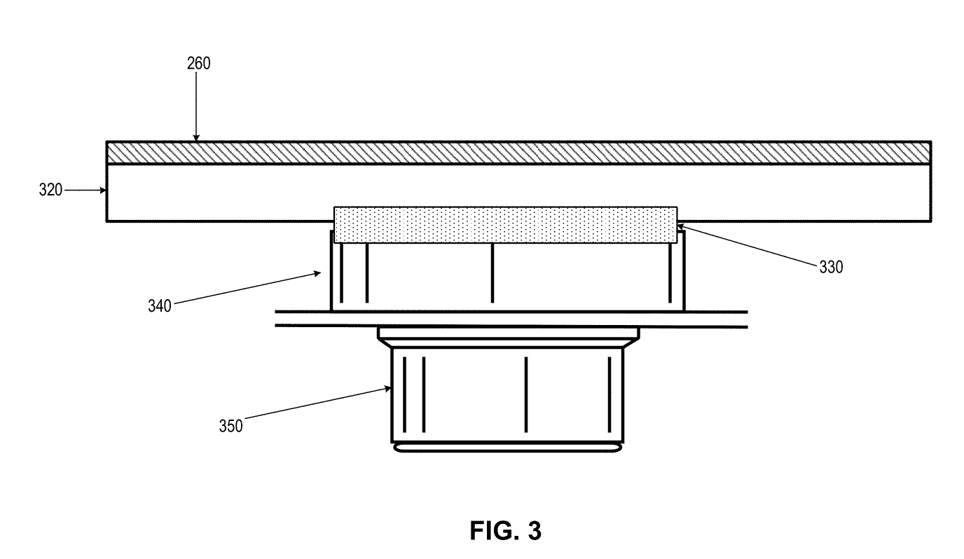

FIG. 3 is a cross section diagram illustrating exemplary workpieces with an absorbing layer applied for welding, according to a disclosed embodiment. In FIG. 3, absorbing layer 260 is on top of a first workpiece contact 320. During the welding process, absorbing layer 260 receives laser beam 50, absorbs energy, and transfers heat to the lower elements. The thickness of absorbing layer 260 may be controlled to improve absorption and heat transfer. While a thick absorbing layer 260 may facility absorption of energy, large absorbing layer 260 thicknesses may also result in high heat dissipation and poor heat conductivity to first workpiece contact 320 and a second workpiece connector 340. Therefore, the thickness of absorbing layer 260 may be optimized for the welding process. In some embodiments, absorbing layer 260 may have a thickness between 3 and 10 um. In these embodiments, absorbing layer 260 may be thick enough to absorb sufficient energy from laser 30, without a large heat dispersion. However, other thicknesses may be considered and may depend on laser 30 characteristics, and properties of metals of first workpiece 110 and second workpiece 100.

First workpiece contact 320 may be positive contact 210 or negative contact 220. It may include metals such as copper and shaped to facilitate contact with second workpiece connector 340. First workpiece contact 320 may be in contact with conductive layers in first workpiece 110, that for example, may be electrically coupled with main power connector 250. Second workpiece connector 340 may be part of second workpiece 100 and be configured to weld with the first workpiece. In some embodiments, second workpiece connector 340 may be a conductive metal that can be easily melted. For example, second workpiece connector 340 may be a piece of copper, bronze, brass, lead, or nickel. The welding process creates welded region 330 between first workpiece contact 320 and second workpiece connector 340.

FIG. 3 also shows a terminal conductor 350 that is electrically connected to one of battery cells 101, and other elements of the second workpiece 100. Terminal conductor 350 may have a thickness selected to prevent transmission of heat from the welding process to battery cells 101. Battery cells 101 may be damaged with heat from laser 30. Therefore, terminal conductor 350 may be electrically conductive, electrically connecting second workpiece connector 340 with other elements of battery cells 101, but may have low thermal conductivity to prevent heat exposure.

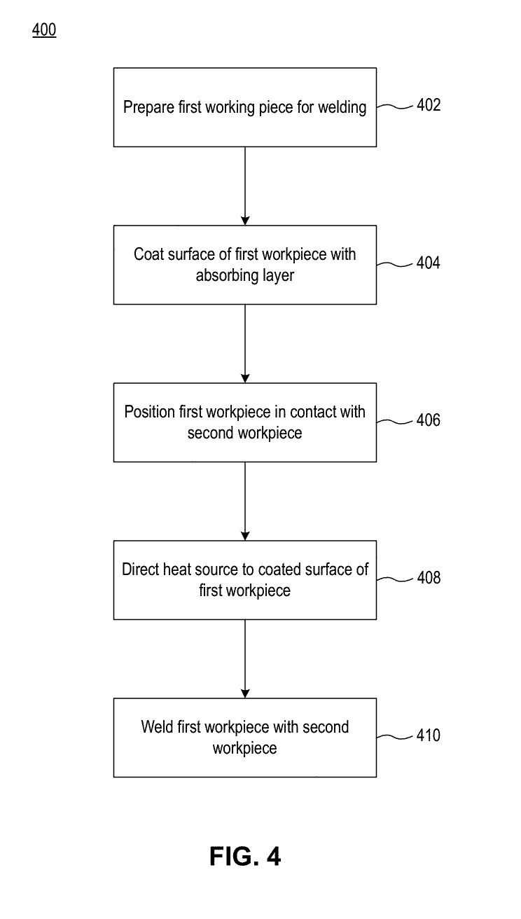

FIG. 4. is a flowchart illustrating an exemplary process for welding a workpiece, according to a disclosed embodiment.

Step 402 includes preparing first workpiece 110 for welding. Preparation in step 402 may include inspection of metal pieces and the removal of any coatings, layers, or oxides from the workpiece. In some embodiments, workpieces are mechanically polished to remove excesses that may prevent adequate welding. For example, workpieces may be mechanically polished with an angle grinder, a saw, or sand paper. In other embodiments, workpieces may be chemically polished to remove undesired layers on the metals. For example, organic acids and/or oxidizing agents may be used to remove organic materials from contacts that may prevent adequate electrical conduction. In yet other embodiments, workpieces may be prepared by being exposed to plasma that removes coatings and layers that may interfere with the welding process. Combinations of these methods are contemplated and may be used in multiple sequences, combination, and cycles.

In step 404, first workpiece 110 is coated with absorbing layer 260. Absorbing layer 260 may be applied in a gaseous, liquid, or solid state. In some embodiments, the coating process may be done with a liquid absorbing layer utilizing, for example, dispenser 40. Liquid absorbing layer 260 may also be applied with a spray, a paint gun, and/or a brush. In these embodiments, absorbing layer 260 may be applied on first workpiece 110 with the patterns described in FIG. 2. In other embodiments, absorbing layer 260 may be deposited on first working piece 110 by placing the piece in a deposition chamber and performing vapor deposition processes to coat the piece. For example, first workpiece 110 may coated by chemical vapor deposition (CVD) or physical vapor deposition (PVD) of inorganic compounds, such as molybdenum disulfide. In such embodiments, first workpiece 110 may be additionally coated with a sacrificial mask, which may patterned on first workpiece 110 to selectively expose first workpiece 110 to the film-forming gases. In yet other embodiments, absorbing layer 260 may be an adhesive layer that coats first workpiece 110 by adhering to it. For example, absorbing layer 260 may be a sheet with multiple layers including at least absorbing layer 260 and a sticking layer. Other additional layers may provide mechanical support.

In step 406, first workpiece 110 and second work piece 100 are placed in contact. Step 406 also includes aligning the two pieces to establish electrical contact between workpieces. In some embodiments first work piece 110 and second workpiece 100 may include complementary fiducial marks to use to align workpieces before the welding process. In other embodiments mechanical alignment methods may be used to align the two workpieces. For example, first workpiece contact 320 may have groves that align with the diameter of second workpiece connector 340. In yet other embodiments, first workpiece 110 and second workpiece 100 may include complementary screw holes to align the workpieces. Step 406 may additionally or alternatively include securing workpieces. For example, both first workpiece 110 and second workpiece 100 may be secured with clamps or braces to support base 102.

In step 408, a heat source, such as laser 30, is positioned to create a weld between first workpiece 110 and second workpiece 100. In some embodiments, in step 408, controller 32 may instruct robotic arm 38 to move laser 30 to the region that will be welded. In some applications, computer aided design (CAD) drawings with coordinates of the welding points may be inputted in controller 32 to sequentially move robot arm 38. CAD drawings may represent first workpiece 110, positive contacts 210, and/or negative contacts 220. Controller 32 may interpret the drawings to determine a list of coordinates with welding positions. For example, software in controller 32 may generate a list of welds coordinates. In such embodiments, controller 32 may also include routines to align the robot with first workpiece 110 or second workpiece 100. In other embodiments, the position of laser 30 may be manually adjusted.

In step 410, first workpiece 110 and second workpiece 100 are welded. Workpieces are welded in the area were laser beam 50 is directed. In some embodiments controller 32 may control the power and exposure time of the laser in step 410. In such embodiments, welding tool 10 may include power sensors that provide information to the controller 32. Controller 32 may be able to adjust exposure timing depending on the information of sensors in welding tool 10. For example, if an energy of 100 J/cm′ is determined to be adequate for a welding process and sensors indicate a power of 10 W/cm² for laser 30, controller 32 may calculate an exposure time of, e.g., 10s. In other embodiments, both power and exposure time may be predefined and controller 32 has no feedback information.

In some applications, multiple welds may need to be created simultaneously between first working piece 110 and second working piece 100. In these applications, one or more lasers 30 could be operated by controller 32 to create these welds. For example, a single laser 30 could be operated to create a single laser beam 50, which is subsequently directed through a beam splitter. In this example, the beam splitter would split the single laser beam 50 into any number of different laser beams that are each used to simultaneously create a different weld. It is contemplated that a beam splitter may be stationary (e.g., mounted to a fixed location on top of first workpiece 110) or movable (e.g., mounted to laser 30, robotic arm 38, or a different arm or gantry mechanism). In another example, multiple lasers 30 mounted to the same or different robotic arms 38 may be operated to simultaneously create the different welds using separate laser beams 50.

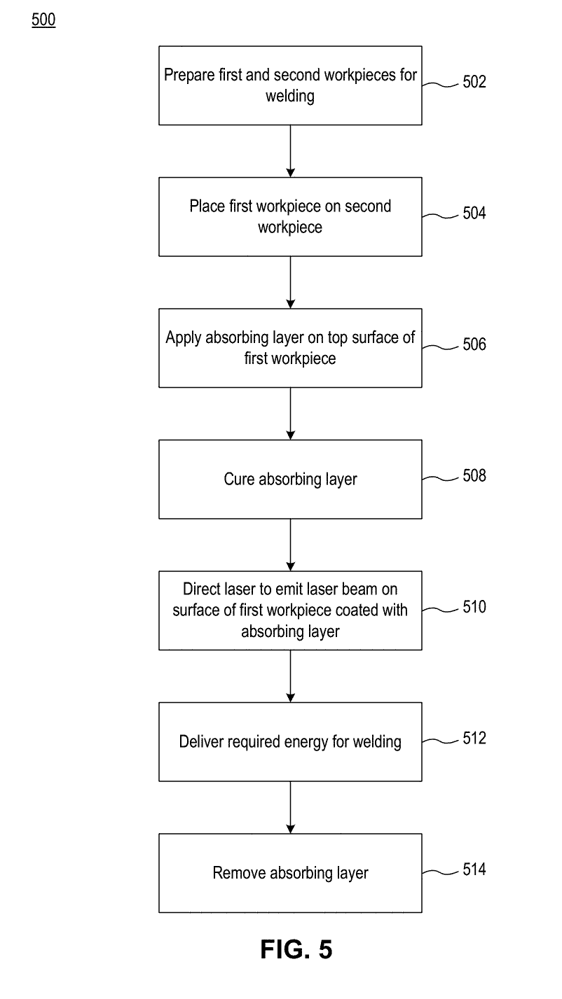

FIG. 5. is a flowchart illustrating an exemplary process for welding first workpiece 110 with second workpiece 100, according to a disclosed embodiment.

In step 502, first workpiece 110 and second workpiece 100 are prepared for welding. Preparations in step 502 may include similar processes as the ones described in step 402 and include chemical, mechanical, and/or plasma polishing.

In step 504, first workpiece 110 is positioned on top of second workpiece 100. The positioning of workpieces in step 504 may follow the processes described in step 406. Workpieces may be aligned and secured using, for example, complementary fiducial marks and/or screws. Alternatively, or additionally, workpieces may be secured to support base 102 with clamps and/or braces.

In step 506, absorbing layer 260 is applied on the exposed surface of first workpiece 110. The coating processes of step 506 may be similar to the ones described in step 404. However, coating methods utilized in step 506 may apply absorbing layer 260 to workpieces, after first workpiece 110 and second workpiece 100 are already aligned. Absorbing layer 260 may be applied with dispenser 40, a solid adhesive layer, CVD, and/or PVD.

Step 508 includes curing and/or processing absorbing layer 260. In some embodiments, organic solvents used for dispersion of other inorganic materials may be air dried. In such embodiments, absorbing layer 260 may lose most of the organic material and leave only the inorganic components, such as molybdenum disulfide. In other embodiments, absorbing layer 260 may be heated to cure the layer. In yet other embodiments catalyzing processes such as ultraviolet light exposure or the application of a curing agent, may be used to cure absorbing layer 260.

Step 510 includes directing a heat source, such as laser 30, to an area that may be welded. For example, in step 510 laser 30 is positioned to direct laser beam 50 towards a coated contact in first workpiece 110. Step 510 may use processes similar to the ones disclosed in step 408, including movement operations executed by controller 32 (operating robotic arm 38) and manual adjustments of the position of laser 30.

In step 512, controller 32 powers the laser to generate laser beam 50 that heats the first workpiece 110 and second workpiece 100 through absorbing layer 260. Step 512 may use similar processes to the ones disclosed in step 410 to control laser 30 power and exposure time. In some embodiments, laser beam 50 may be powered for a fixed amount of time and a set power. In other embodiments, controller 32 may dynamically determine the amount of time to power laser 30 based on, for example, sensors in welding tool 10. In yet other embodiments, the power of laser 30 may be dynamically set by controller 32.

Step 514 includes removing the absorbing layer 260 from the first piece. In some embodiments, it may do so with mechanical or chemical polishing similar to the one used in step 502 for workpieces preparation.

Another aspect of the disclosure is directed to a system for welding workpieces. The system includes controller 32 coupled with a non-transitory computer-readable medium storing instructions which, when executed, cause one or more processors of controller to perform the methods discussed herein. The computer-readable medium may include volatile or non-volatile, magnetic, semiconductor, tape, optical, removable, non-removable, or other types of computer-readable medium or computer-readable storage devices. For example, the computer-readable medium may be the included in controller 32, or a web-based storage medium having the computer instructions stored thereon, as disclosed. In some embodiments, the computer-readable medium may be a disc or a flash drive having the computer instructions stored thereon.

It will be apparent to those skilled in the art that various modifications and variations may be made to the disclosed welding methods and systems. Other embodiments will be apparent to those skilled in the art from consideration of the specification and practice of the disclosed welding methods and systems. It is intended that the specification and examples be considered as exemplary only, with a true scope being indicated by the following claims and their equivalents.

What is claimed is:

1. A welding method comprising:
providing a first workpiece and a second workpiece;
positioning the first workpiece to contact the second workpiece;
coating a portion of a selected one of the first and second workpieces with an absorbing layer; and
welding the first workpiece and the second workpiece by heating the selected one of the first and second workpieces through the absorbing layer.

2. The welding method of claim 1, further comprising:
removing the absorbing layer after the first workpiece and the second workpiece are welded.

3. The welding method of claim 1, wherein the providing includes providing the first workpiece and the second workpiece as metal workpieces.

4. The welding method of claim 1, wherein the coating includes providing the absorbing layer as an electrically nonconductive layer.

5. The welding method of claim 4, wherein the coating further includes providing the absorbing layer as an inorganic compound with a solvent.

6. The welding method of claim 5, where in the inorganic compound is molybdenum disulfide.

7. The welding method of claim 4, wherein the coating further includes coating the selected one of the first and second workpieces with the absorbing layer having a thickness of less than 10 microns.

8. The welding method of claim 4, wherein the coating further includes providing the absorbing layer as a material that absorbs at least one of infrared and micro wavelengths.

9. The welding method of claim 1, wherein the coating includes spraying the absorbing layer on the portion of the selected one of the first and second workpieces.

10. The welding method of claim 1, wherein the welding includes directing a laser beam onto the coated portion to heat the selected one of the first and second workpieces.

11. A welding method comprising:
providing a first workpiece;
coating at least a portion of the first workpiece with an absorbing layer;
positioning the first workpiece and a second workpiece in contact, with the absorbing layer exposed; and
welding the first workpiece to the second workpiece by heating the first workpiece through the absorbing layer.

12. The welding method of claim 11, further comprising:
removing the absorbing layer after the first workpiece and the second workpiece are welded.

13. The welding method of claim 11, wherein the coating includes providing the absorbing layer as an electrically nonconductive layer.

14. The welding method of claim 13, wherein the coating further includes providing the absorbing layer as an inorganic compound with a solvent.

15. The welding method of claim 14, where in the inorganic compound is molybdenum disulfide.

16. The welding method of claim 13, wherein the coating further includes coating the first and second workpieces with the absorbing layer having a thickness of less than 10 microns.

17. The welding method of claim 13, wherein the coating further includes providing the absorbing layer as a material that absorbs at least one of infrared and micro wavelengths.

18. The welding method of claim 11, wherein the coating includes depositing the absorbing layer on the portion of the first with vapor deposition.

19. The welding method of claim 11, wherein the welding includes directing a laser beam onto the coated portion to heat the selected one of the first and second workpieces.

20. A system for welding workpieces, the system comprising:
a heat source configured to heat a first workpiece;
a coating device configured to coat an absorbing layer onto the first workpiece;
an actuator, coupled to the heat source and the coating device, to move the heat source along a first axis and a second axis; and
a controller to control the actuator, heat source, and the depositing device;
wherein, the actuator executes operations to:
coat, by the coating device, an absorbing layer onto the first working piece; and
weld, by the heat source, the first workpiece to a second workpiece in contact with the first working piece, by heating through the absorbing layer.
